(19) United States
(12) Patent Application Publication
(10) Pub. No.: US 2014/0023945 A1
(43) Pub. Date: Jan. 23, 2014

(54) AIRCRAFT FUEL CELL SYSTEM

(71) Applicants: Michael Jay Epstein, Cincinnati, OH (US); Randy M. Vondrell, Cincinnati, OH (US); Robert Harold Weisgerber, Cincinnati, OH (US); Georgia C. Karvountzi, Cincinnati, OH (US)

(72) Inventors: Michael Jay Epstein, Cincinnati, OH (US); Randy M. Vondrell, Cincinnati, OH (US); Robert Harold Weisgerber, Cincinnati, OH (US); Georgia C. Karvountzi, Cincinnati, OH (US)

(73) Assignee: GENERAL ELECTRIC COMPANY, Schenectady, NY (US)

(21) Appl. No.: 13/876,667

(22) PCT Filed: Sep. 30, 2011
(86) PCT No.: PCT/US2011/054403

§ 371 Date: Oct. 10, 2013

Related U.S. Application Data
(60) Provisional application No. 61/388,411, filed on Sep. 30, 2010.

(51) Int. Cl. H01M 8/04

(52) U.S. Cl. CPC H01M 8/04201
USPC 429/415; 429/513; 429/505; 429/434; 429/429

(57) ABSTRACT

An aircraft system comprising a fuel storage system comprising a first fuel tank capable of storing a first fuel and a second fuel tank capable of storing a second fuel is disclosed herein. The aircraft system further comprises a fuel cell system comprising a fuel cell capable of producing electrical power using at least one of the first fuel or the second fuel, and a fuel delivery system capable of delivering a fuel from the fuel storage system to the fuel cell system.

### CROSS-REFERENCE TO RELATED APPLICATION

This is a national stage application under 35 U.S.C. § 371(c) prior-filed, co-pending PCT patent application serial number PCT/U.S. 11/54403, filed on Sep. 30, 2011, which claims priority to U.S. provisional application serial number 61/388441, filed Sep. 30, 2010, the entire contents of which are incorporated herein by reference.

### BACKGROUND OF THE INVENTION

The technology described herein relates generally to aircraft systems, and more specifically to aircraft fuel cell systems.

Fuel cells are electrochemical devices that convert a supplied fuel into electricity. It generates electricity inside a cell through reactions between the fuel and an oxidant, triggered in the presence of an electrolyte. Fuel cells are characterized by their electrolyte material. A solid oxide fuel cell (“SOFC”) is an electrochemical conversion device that produces electricity directly from oxidizing a fuel. The SOFC has a solid oxide or ceramic, electrolyte. The reactants flow into the cell, and the reaction products flow out of it, while the electrolyte remains within the cell. Fuel cells are thermodynamically open systems that consume the reactants supplied from the external sources, unlike conventional batteries that store electrical energy chemically (thermodynamically closed). Fuel cells, like SOFC, typically have high efficiency, long-term stability, fuel flexibility, and low emissions. They operate at higher temperatures, and managing such heat generation can be a challenge in an aircraft system environment.

Accordingly, it would be desirable to have aircraft systems using fuel cells with improved capability to manage heat generated during fuel cell operation.

### BRIEF DESCRIPTION OF THE INVENTION

The above-mentioned need or needs may be met by embodiments disclosed herein which provide an aircraft system comprising a fuel storage system comprising a first fuel tank capable of storing a first fuel and a second fuel tank capable of storing a second fuel. The aircraft system further comprises a fuel cell system comprising a fuel cell capable of producing electrical power using at least one of the first fuel or the second fuel, and a fuel delivery system capable of delivering a fuel from the fuel storage system to the fuel cell system.

In an embodiment, an aircraft system comprising a fuel storage system comprising a first fuel tank configured to store a first fuel and a second fuel tank configured to store a second cryogenic liquid fuel is disclosed. The aircraft system further comprises a fuel cell system comprising a fuel cell configured to produce electrical power using at least one of the first fuel or the second fuel, and a fuel delivery system configured to deliver a fuel from the fuel storage system to the fuel cell system. The fuel cell system generates power using a portion of a cryogenic fuel used by a dual fuel propulsion system and supplies at least a portion of the electrical power used by the aircraft system.

### BRIEF DESCRIPTION OF THE DRAWINGS

The technology described herein may be best understood by reference to the following description taken in conjunction with the accompanying drawing figures in which:

FIG. 1 is an isometric view of an exemplary aircraft system having a dual fuel propulsion system; and

FIG. 2 is a schematic view of an embodiment of a fuel cell system.

### DETAILED DESCRIPTION OF EXEMPLARY EMBODIMENTS OF THE INVENTION

Referring to the drawings herein, identical reference numerals denote the same elements throughout the various views.

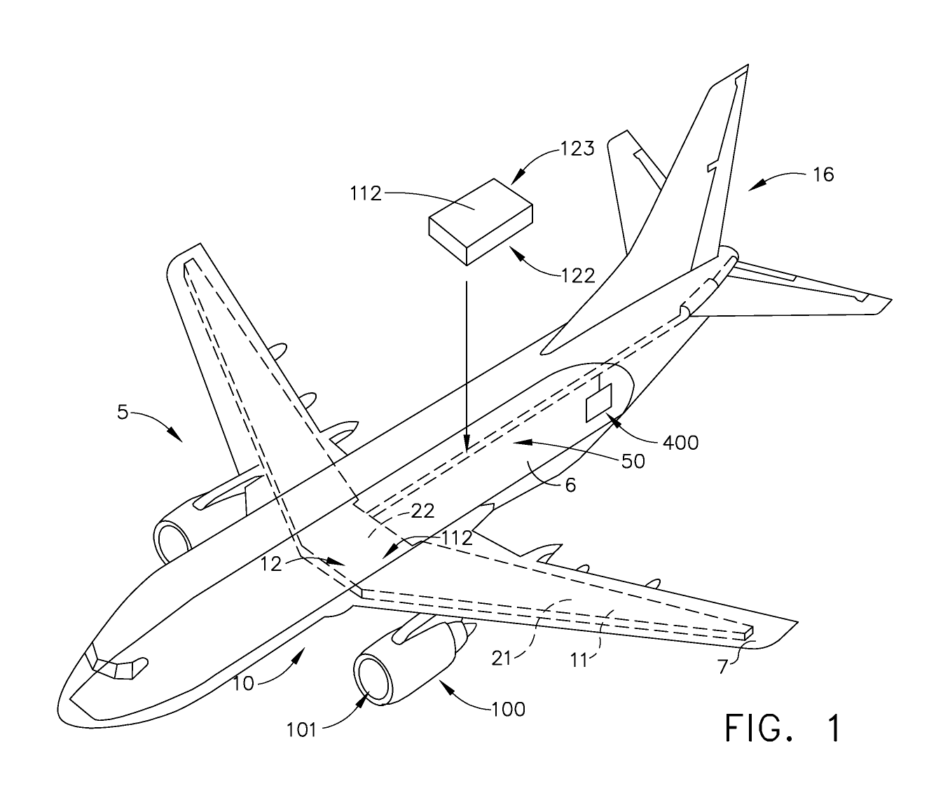

FIG. 1 shows an aircraft system 5 according to an embodiment of the present invention. The exemplary aircraft system 5 has a fuselage 6 and wings 7 attached to the fuselage. The aircraft system 5 has a propulsion system 100 that produces the propulsive thrust required to propel the aircraft system in flight. Although the propulsion system 100 is shown attached to the wing 7 in FIG. 1, in other embodiments it may be coupled to other parts of the aircraft system 5, such as, for example, the tail portion 16.

The exemplary aircraft system 5 has a fuel storage system 10 for storing one or more types of fuels that are used in the propulsion system 100. The exemplary aircraft system 5 shown in FIG. 1 uses two types of fuels, as explained further below herein. Accordingly, the exemplary aircraft system 5 comprises a first fuel tank 21 capable of storing a first fuel 11 and a second fuel tank 22 capable of storing a second fuel 12. In the exemplary aircraft system 5 shown in FIG. 1, at least a portion of the first fuel tank 21 is located in a wing 7 of the aircraft system 5. In an embodiment, shown in FIG. 1, the second fuel tank 22 is located in the fuselage 6 of the aircraft system near the location where the wings are coupled to the fuselage. In an alternative embodiment, the second fuel tank 22 may be located at other suitable locations in the fuselage 6 or the wing 7. In an embodiment, the aircraft system 5 may comprise an optional third fuel tank 123 capable of storing the second fuel 12. The optional third fuel tank 123 may be located in an aft portion of the fuselage of the aircraft system, such as for example shown schematically in FIG. 1.

As further described later herein, the propulsion system 100 shown in FIG. 1 is a dual fuel propulsion system that is capable of generating propulsive thrust by using the first fuel 11 or the second fuel 12 or using both first fuel 11 and the second fuel 12. The exemplary dual fuel propulsion system 100 comprises a gas turbine engine 101 capable of generating a propulsive thrust selectively using the first fuel 11, or the second fuel 21, or using both the first fuel and the second fuel at selected proportions. The first fuel may be a conventional liquid fuel such as a kerosene based jet fuel such as known in the art as Jet-A, JP-8, or JP-5 or other known types or grades. In an embodiment described herein, the second fuel 12 is a cryogenic fuel that is stored at very low temperatures. In an embodiment described herein, the cryogenic second fuel 12 is Liquefied Natural Gas (alternatively referred to herein as “LNG”). The cryogenic second fuel 12 is stored in the fuel tank at a low temperature. For example, the LNG is stored in the second fuel tank 22 at about −265 Deg. F at an absolute pressure of about 15 psia. The fuel tanks may be made from known materials such as titanium, Inconel, aluminum or composite materials.

The exemplary aircraft system 5 shown in FIG. 1 comprises a fuel delivery system 50 capable of delivering a fuel from the fuel storage system 10 to the propulsion system 100. Known fuel delivery systems may be used for delivering the conventional liquid fuel, such as the first fuel 11. In an embodiment described herein, and shown in FIG. 1, the fuel delivery system 50 is configured to deliver a cryogenic liquid fuel, such as, for example, LNG, to the propulsion system 100 through conduits that transport the cryogenic fuel.

The embodiment of the aircraft system 5 shown in FIG. 1 further includes a fuel cell system 400, comprising a fuel cell capable of producing electrical power using at least one of the first fuel 11 or the second fuel 12. The fuel delivery system 50 is capable of delivering a fuel from the fuel storage system 10 to the fuel cell system 400. In an embodiment, the fuel cell system 400 generates power using a portion of a cryogenic fuel 12 used by a dual fuel propulsion system 100.

Aircraft systems such as the exemplary aircraft system 5 described above and illustrated in FIG. 1, as well as methods of operating same, are described in greater detail in commonly-assigned, co-pending patent application Ser. No. PCT/U.S. 11/54415, filed on September 30, 2011, entitled “Fuel Storage System”, the disclosure of which is hereby incorporated in its entirety by reference herein.

In an embodiment shown herein, the heat generated in the fuel cell may use optional heat exchangers and optional expanders.

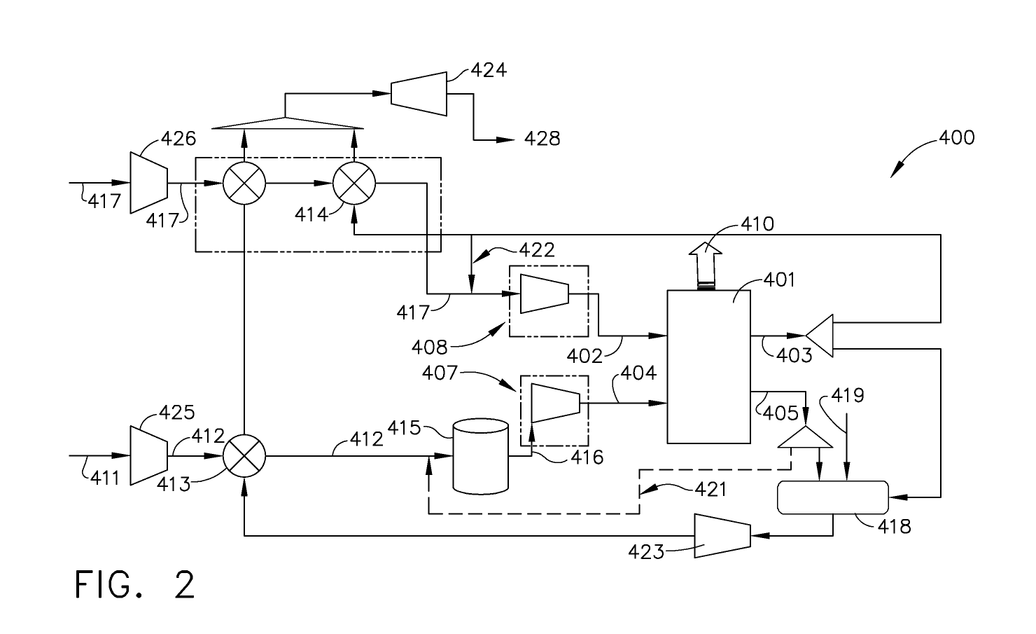

As shown in FIG. 1, the aircraft system 5 further includes a fuel cell system 400, such as, for example, shown in FIG. 2, comprising a fuel cell 401 capable of producing electrical power 410 using at least one of the first fuel 11 or the second fuel 12. In an embodiment, the second fuel 12 is a cryogenic fuel, such as, for example, Liquefied Natural Gas (“LNG”). During the operation the aircraft system 5, the fuel cell system 400 can supply at least a portion of the electrical power used by the aircraft system 5.

FIG. 2 shows an embodiment of a fuel cell system 400 having a fuel cell 401. The fuel cell 401 comprises an anode portion 407 and a cathode portion 408. The anode portion 407 is capable of receiving chemical products 416, such as, for example, hydrogen, from a known pre-reformer 415. Pre-reforming optimizes the process and avoids carbon deposition during the internal reforming inside the fuel cell. The cathode portion is capable of receiving air 417, such as, for example, compressed air from the propulsion system 100. Reaction products exhaust from the fuel cell anode portion (see item 405) and the cathode portion (see item 403). In an embodiment, the fuel cell system 400 further comprises optionally an anode exhaust recycle system 421 that recycles a portion of the anode exhaust 405 products to the pre-reformer 415. In an embodiment, the fuel cell system 400 further comprises optionally a cathode exhaust recycle system 422 that recycles a portion of the cathode exhaust 403 products to the cathode portion 408. In an embodiment, cathode exhaust 403 products may be directed back to the high pressure turbine (HPT) of the main propulsion system. Planar SOFC Fuel exhaust may typically be in the range of approximately 800 degrees C. to approximately 850 degrees C.

As shown in FIG. 2, the fuel cell system 400 may further comprise optionally a high temperature heat exchanger 413, 414 to recover at least a portion of heat from the cathode exhaust 403 and/or the anode exhaust 405 from the fuel cell 401. The optional heat exchanger 413 transfers at least a portion of the heat recovered from the anode exhaust (and an optional burner 418 and/or an optional expander 423) to a fuel 411 (such as, for example, a cryogenic fuel such as LNG in liquid or gaseous form) supplied to the fuel cell 401. In an embodiment, the optional heat exchanger 414 transfers at least a portion of the heat recovered from the cathode exhaust 403 to air flow 417 supplied to the fuel cell 401. The air flow 417 may be extracted from a suitable source, such as a compressor (not shown), in the propulsion system 100. When the main propulsion system operates, high pressure compressor (HPC) bleed air can be used to run the fuel cell and high pressure turbine (HPT) bleed air can be used to preheat the inlet stream to the fuel cell anode. Although performance of SOFC in theory improves with pressurization, typically pressurization higher than 15:1 is not achieved because degradation of the stack typically accelerates. The expanders and compressors depicted in FIG. 2 are typically only utilized when the main propulsion system is not operating, such as, for example, if the SOFC is functioning as an auxiliary power unit (APU).

In an embodiment, the fuel cell system 400 further comprises an optional burner 418 that provides power during start up of the system, using a start up fuel 419. The products of burning from the burner 418 may be expanded in an optional expander 423 that is capable of extracting energy from a portion of an expander 423. The expander may be a turbine, driven by the gases from the burner. In an embodiment, the optional expander 423 may provide power to another unit, such as for example, an optional compressor 425. Additional optional expanders 424 may be used optionally to extract additional power from exhaust from the fuel cell system 400 to provide power to another unit, such as for example, an optional compressor 426. After passing through expander 424, exhaust may be discharged overboard at 428.

Operation of an embodiment of a fuel cell system 400 can be described as follows: As shown in FIGS. 1 and 2, natural gas may be used in combination with air in a fuel cell 401 to produce electric power 410 that can be utilized by and/or integrated with the aircraft system 5 electric supply and load grid. Alternatively the fuel cell 401 can be utilized to operate a resistor and/or fan for other uses. An alternative embodiment would include an inverter so that electric power could be net metered (supplied from the aircraft 5) to ground load sources while an aircraft is parked at the gate. A high temperature fuel cell 401 can reach up to 60% efficiency with substantially little or no NOx emissions. Fuel and slightly pressurized air are supplied to the system 400. The fuel 411, 12, 112 is passed through a pre-reformer 415 where initial reforming of the fuel occurs. After equilibrium has been reached at an exit temperature of about 500° C. (932° F.), the pre-reformed fuel enters the internal reforming unit and final reforming occurs. Different kinds of fuel reformers are known and available. The system 400 should be water neutral. Thus, the partial oxidation reformer 415 is the first option. An alternative option considered is the auto-thermal reformer. SOFC anode exhaust 405 that contains water may be recycled back to the reformer 415 to provide the product water needed. In an embodiment, a water pump with a steam generator providing steam from a water tank with a condenser may be used during start-up of the fuel cell system 400. Both options maintain water neutrality. The reformed fuel reaches the anode portion 407 compartment of the fuel cell at about 625° C. (1157° F.). Temperatures are monitored to avoid carbon deposition. In an embodiment, the air 417 enters the SOFC cathode at about 700° C. (1292° F.). The air temperature rise in the fuel cell is about 100 to 200° C. The system 400 can be designed to operate with a fixed air temperature rise through the stack in 401. This assumption would then drive the airflow requirement through the fuel cell 401. The air temperature rise is measured from the stack inlet air manifold to the stack outlet air manifold. The air temperature rise is usually limited by the cell temperature gradients. The relationship between the air temperature rise (or the airflow) and the maximum allowable cell temperature gradient is dependent on the stack and cell design, and can be designed using known engineering methods. In an embodiment of the invention, the SOFC system operating temperature is about 800° C. (1472° F.). The fuel cell inlet air preheat may accomplished with an optional recycling part of the stack cathode exhaust stream to the air inlet or using optional high temperature heat exchangers, or combination of the two. The recycling option is the most desirable as high temperature heat exchangers may increase the cost and weight of the system. In addition, high pressure turbine (HPT) bleed air from the main propulsion system may be utilized to preheat the inlet streams to the SOFC.

This written description uses examples to disclose the invention, including the best mode, and also to enable any person skilled in the art to make and use the invention. The patentable scope of the invention may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft system comprising:
a fuel storage system comprising a first fuel tank configured to store a first fuel and a second fuel tank configured to store a second fuel;
a fuel cell system comprising a fuel cell configured to produce electrical power using at least one of the first fuel or the second fuel; and
a fuel delivery system configured to deliver a fuel from the fuel storage system to the fuel cell system.

2. The aircraft system according to claim 1, wherein the second fuel is a cryogenic liquid fuel.

3. The aircraft system according to claim 1, wherein the second fuel is Liquefied Natural Gas (LNG).

4. The aircraft system according to claim 1, wherein the fuel cell comprises an anode portion capable of configured to receive chemical products from a reformer.

5. The aircraft system according to claim 4, wherein chemical products includes hydrogen.

6. The aircraft system according to claim 1, wherein the fuel cell comprises a cathode portion configured to receive air.

7. The aircraft system according to claim 6, wherein the air is compressed air.

8. The aircraft system according to claim 1, wherein the fuel cell system further comprises an anode exhaust recycle system.

9. The aircraft system according to claim 1, wherein the fuel cell system further comprises a cathode exhaust recycle system.

10. The aircraft system according to claim 1, wherein the fuel cell system further comprises a heat exchanger to recover at least a portion of heat from at least a portion of an exhaust from the fuel cell.

11. The aircraft system according to claim 10, wherein the heat exchanger transfers at least a portion of the heat recovered to a fuel supplied to the fuel cell.

12. The aircraft system according to claim 10, wherein the heat exchanger transfers at least a portion of the heat recovered to air supplied to the fuel cell.

13. The aircraft system according to claim 1, wherein the fuel cell system further comprises a burner adapted to provide power for a start-up using a start-up fuel.

14. The aircraft system according to claim 1, wherein the fuel cell system further comprises at least one expander that is capable of extracting energy from a portion of an exhaust.

15. The aircraft system according to claim 14, wherein the at least one expander provides power to a compressor.

16. The aircraft system according to claim 1, wherein the fuel cell system supplies at least a portion of the electrical power used by the aircraft system.

17. The aircraft system according to claim 1, wherein the fuel cell system generates power using a portion of a cryogenic fuel used by a dual fuel propulsion system.

18. An aircraft system comprising:
a fuel storage system comprising a first fuel tank configured to store a first fuel and a second fuel tank configured to store a second cryogenic liquid fuel;
a fuel cell system comprising a fuel cell configured to produce electrical power using at least one of the first fuel or the second fuel; and
a fuel delivery system configured to deliver a fuel from the fuel storage system to the fuel cell system;
wherein the fuel cell system generates power using a portion of a cryogenic fuel used by a dual fuel propulsion system and supplies at least a portion of the electrical power used by the aircraft system.

19. The aircraft system according to claim 18, wherein the second fuel is Liquefied Natural Gas (LNG).

20. The aircraft system according to claim 19, wherein the fuel cell system further comprises a heat exchanger to recover at least a portion of heat from at least a portion of an exhaust from the fuel cell.
